(19) United States
(12) Patent Application Publication
(10) Pub. No.: US 2010/0285832 A1
(43) Pub. Date: Nov. 11, 2010

(54) ELECTRONIC APPARATUS AND ASSOCIATED ELEMENTS AND METHODS

(75) Inventor: Steve Mosley, London (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/665,743

(22) PCT Filed: Jun. 19, 2007
(86) PCT No.: PCT/EP2007/005389

§ 371 Date: Jul. 19, 2010

(51) Int. Cl. H04W 88/02; G08B 13/14

(52) U.S. Cl. 455/550.1; 340/572.1

(57) ABSTRACT

A user portable electronic apparatus (200) comprising circuitry for associating with a user portable element (100), the circuitry for associating providing a plurality of regions each allowing for association with the user portableelement (100), and wherein the apparatus (200) is arranged to be provided with data, associated with the element, upon association of the element with the user portable electronic apparatus.

### BACKGROUND

User portable electronic devices, such as communications devices (including radiotelephones providing for audio/video communication and/or email/Short Message Service (SMS)/Multimedia Message Service (MMS) functions), are known. Data can be provided to such devices over an air interface, and/or using a memory card which is insertable into a connection region which is located within the interior of the device or on a minor exterior face of the device. Such data may comprise one or more of data relating to a user interface (e.g. phone profile), ring tone, image, wallpaper, audio, still/moving images including video, software to be run on the device, and links to digital downloads.

Radio-frequency identification (RFID) is an automatic identification method, relying on storing and remotely retrieving data using devices called RFID tags or transponders. An RFID tag is an object that can be attached to or incorporated into a product, animal, or person for the purpose of identification using radio waves. All RFID tags contain at least two parts. One is an integrated circuit for storing and processing information, modulating and demodulating a radio frequency (RF) signal, and perhaps other specialized functions. The second is an antenna element for receiving and transmitting the signal.

The RFID tag can automatically be read from several meters away and does not have to be in the line of sight of the reader. RFID tags come in three general varieties: passive, semi-passive (also known as battery-assisted), or active. Passive tags require no internal power source, whereas semi-passive and active tags require a power source, usually a small battery.

As mentioned above, passive RFID tags have no internal power supply. The minute electrical current induced in the antenna by the incoming radio frequency signal provides just enough power for the CMOS integrated circuit in the tag to power up and transmit a response. Most passive tags signal by backscattering the carrier wave from the reader. This means that the tag antenna element has to be designed to both collect power from the incoming signal, and also to transmit the outbound backscatter signal. The response of a passive RFID tag is not necessarily just an ID number; the tag chip can contain non-volatile EEPROM for storing data.

Passive tags currently have practical read distances ranging from about 10 cm (4 in.) (ISO 14443) up to a few meters (Electronic Product Code (EPC) and ISO 18000-6), depending on the chosen radio frequency and antenna design/size. Due to their simplicity in design they are also suitable for manufacture with a printing process for the antennas. The lack of an onboard power supply means that the device can be quite small: commercially available products exist that can be embedded in a sticker, or under the skin in the case of low frequency RFID tags.

Unlike passive RFID tags, active RFID tags have their own internal power source, which is used to power the integrated circuits, and broadcast the signal to the reader. Active tags are typically much more reliable (e.g. fewer errors) than passive tags due to the ability for active tags to conduct a “session” with a reader. Active tags, due to their onboard power supply, also transmit at higher power levels than passive tags, allowing them to be more effective in “RF challenged” environments like water (including humans/cattle, which are mostly water), metal (shipping containers, vehicles), or at longer distances. Many active tags have practical ranges of hundreds of meters, and a battery life of up to 10 years. Active tags typically have much longer range (approximately 100 m/300 feet) and larger memories than passive tags, as well as the ability to store additional information sent by the transceiver.

Semi-passive tags are similar to active tags as they have their own power source, but the battery is used just to power the microchip and not broadcast a signal. The RF energy is reflected back to the reader like a passive tag.

The listing or discussion of a prior-published document in this specification should not necessarily be taken as an acknowledgement that the document is part of the state of the art or is common general knowledge. One or more embodiments of the present invention may use one or more of the components described in the background section.

### SUMMARY

According to a first aspect, there is provided a user portable electronic apparatus comprising circuitry for associating with a user portable element, the circuitry for associating providing a plurality of regions each allowing for association with the user portable element, and wherein the apparatus is arranged to be provided with data, associated with the element, upon association of the element with the apparatus.

The circuitry for associating may comprise a single element for associating, the single element for associating arranged to provide for associating over a multiple number of the plurality of regions.

The circuitry for associating may comprise a single element for associating for all of the plurality of regions.

The circuitry for associating may comprise respective elements for associating for respective regions. The circuitry for associating may comprise a respective element for associating for each respective region.

The plurality of regions may comprise an exterior major (e.g. outer/rear/front) face of the apparatus.

The circuitry for associating may be arranged to be associated with the user portable element without physical contact between the element and the one or more plurality of regions of the apparatus.

The circuitry for associating may be arranged to associate with the user portable element using near field (e.g. RFID/Bluetooth™) radio communication.

The circuitry for associating may comprise one or more (e.g. active/passive) radiative/inductive coupling element(s) for associating with the user portable element.

The circuitry for associating may comprise one or more antenna element(s) for RFID, the one or more elements for RFID for associating the user portable element with the apparatus.

The apparatus may be arranged to provide power to the user portable element to allow (e.g. by using the circuitry for associating or more specifically the antenna/coupling element of the circuitry for associating) for association between the apparatus and the user portable element.

The apparatus may be arranged to be (e.g. automatically, or under user-authorisation) associated with the user portable element upon physical contact of the apparatus and the user portable element over one or more regions of the apparatus.

The apparatus may be arranged to allow (e.g. permanent/releasable) attachment of the user portable element on an exterior face of the apparatus to allow for the provision (e.g. transfer/unlocking) of data to the apparatus upon attachment of the element to the exterior face of the portable electronic apparatus.

The apparatus may comprise one or more elements for locking located on the exterior of a major face of the apparatus to allow for locking with one or more complementary elements for locking located on the exterior of a major face of the user portable element. The one or more elements for locking may be arranged to provide locking by first engaging the apparatus and the user portable element with one another and then turning/twisting them relative to one another.

The apparatus may comprise circuitry for discriminating between different types of user portable elements. The apparatus may comprise circuitry for discriminating between the data associated with one user portable element and the data associated with another user portable element.

The apparatus may be arranged such that the association of the apparatus with the user portable element allows for the (e.g. automatic/user initiated) transfer of data to the apparatus.

The apparatus may be arranged such that the association of the apparatus with the user portable element allows for the (e.g. automatic/user initiated) transfer of data from the user portable element to the apparatus.

The apparatus may be arranged such that the association of the apparatus with the user portable element allows for the (e.g. automatic/user initiated) transfer of data from a remote source (e.g. server) to the apparatus.

The apparatus may be arranged such that the association of the apparatus with the user portable element allows for the unlocking of data for the apparatus.

The apparatus may be arranged such that the association of the apparatus with the user portable element allows for the unlocking of data for the apparatus located on the user portable element.

The apparatus may be arranged such that the association of the apparatus with the user portable element allows for the unlocking of data for the apparatus located on the apparatus.

The apparatus may be arranged such that the association of the apparatus with the user portable element allows for the unlocking of data for the apparatus located on a remote source.

The apparatus may be arranged such that the association of the apparatus with the user portable element allows for the unlocking of data for the apparatus located on a user removeable circuit (e.g. memory card) which is to be/has been read by the apparatus.

The apparatus may be arranged such that the association of the apparatus and the user portable element provides data to the apparatus using the circuitry for associating.

The apparatus may comprise circuitry for far-field (e.g. cellular/radio/Wireless Local Area Network (WLAN), satellite communications), and wherein the apparatus is arranged such that the association of the apparatus and the user portable element allows for the provision of data to the apparatus using the circuitry for far-field communications.

The apparatus may comprise circuitry for far-field communications, and wherein the apparatus is arranged such that the association of the apparatus and the user portable element provides for unlocking of data received (e.g. before/after the associating) by the apparatus using the circuitry for far-field communications.

The circuitry for associating may be arranged to be able to associate with multiple user portable elements at one time.

The circuitry for associating may be arranged to be able to associate with multiple user portable elements at one time using the plurality of regions of the apparatus.

The apparatus may be arranged to perform other functions when the element is not connected. The apparatus may be arranged to provide radio-telecommunications, emailing, web-browsing, and/or audio/video play/recording functions.

The apparatus may be device module. The apparatus may be a radiotelephone device.

According to a second aspect, there is provided a user portable element arranged to be associatable with a user portable electronic apparatus over a plurality of regions of the portable electronic apparatus, each region of the apparatus for allowing for association with the user portable element, wherein the user portable element comprises circuitry for associating and wherein the circuitry for associating is arranged to allow for the provision (e.g. transfer/unlocking) of data, associated with the element, to the apparatus upon association of the user portable element with the apparatus via one or more of the plurality of regions of the portable electronic apparatus.

The element may be (e.g. substantially) smaller than the apparatus.

The element according to any preceding element claim, wherein the element is for associating with the apparatus via a exterior major face of the element.

The element may comprise a graphic/text icon on the exterior of the element, the graphic/text icon and the data associated with the element being arranged to be associated with one another.

The element may comprise circuitry for near field communication arranged to allow for the provision of the data to the apparatus.

The element may comprise circuitry arranged to allow association with the apparatus without physical contact between the element and the one or more regions of the apparatus.

The element may be arranged to allow for the provision of the data using (e.g. active/passive) radiative/inductive coupling between the element and the apparatus.

The element may comprise one or more antenna elements for RFID arranged to allow for the provision of the data to the apparatus.

The element may comprise a power source (e.g. battery (rechargeable/non-chargeable) to allow for the provision of the data.

The element may be arranged to receive power from the electronic apparatus to allow for the provision of the data to the electronic apparatus.

The element may be arranged to be associated with the apparatus upon physical contact between the element and the one or more regions of the apparatus.

The element may be arranged to be (e.g. permanently/releasably) attachable (e.g. using an adhesive and/or mechanical locking element) on the exterior (e.g. major/rear/front) face of the portable electronic apparatus, and wherein the element is arranged to allow for the provision (e.g. transfer/unlocking) of data to the apparatus upon attachment of the element to the exterior (e.g. major) face of the portable electronic apparatus.

The element may comprise one or more locking elements to allow for releasable attachment to the apparatus to enable the association of the element with the apparatus.

The element may comprise circuitry to allow the type of element to be discriminated from other element types.

The element may comprise circuitry to allow the data associated with the element to be discriminated from the data associated with other elements.

The element may comprise memory circuitry to store the data.

The element may comprise memory circuitry to store one or more security codes to unlock the data.

The data associated with the element may be security locked, and wherein the element is arranged such that attachment of the element to the exterior (e.g. major) face of the element allows the provision of one or more security codes to unlock the data to allow for the provision (e.g. transfer, unlocking) of the data to the electronic apparatus.

The element may comprise memory circuitry arranged to contain part, or all, of the data, and wherein the element is arranged such that attachment of the element on an exterior (e.g. major) face of the apparatus allows for the transfer of at least part of, and/or all, of the data from the element memory to the apparatus.

The element may be arranged to provide the data using the circuitry for associating.

The element may be arranged to provide one or more security codes using the circuitry for associating to allow the apparatus to be provided with the data (e.g. by downloading (e.g. previously/subsequently) obtained data from a remote source/from a local memory card/circuitry associated with the apparatus).

The element may be arranged to be dedicated to only provide the associated data.

The element may comprise one or more elements for locking located on the exterior of a (e.g. major) face of the user portable element to allow for locking with one or more complementary elements for locking located on the exterior of a (e.g. major) face of the apparatus.

The element may comprise one or more locking elements located on the exterior of a major face of the user portable element to allow for locking with one or more complementary locking elements located on the exterior of a major face of the apparatus.

The element may be arranged to comprise writable memory to which an associated portable electronic apparatus can write data.

The data may comprise one or more of a user interface, ring tone, image, wallpaper, video, software and links to digital downloads.

According to a third aspect, there is provided the combination of the user portable electronic apparatus and the user portable element as disclosed.

According to a fourth aspect, there is provided a computer program for a user portable electronic apparatus, the apparatus comprising circuitry for associating with a user portable element, the circuitry for associating providing a plurality of regions each allowing for association with the user portable element, and wherein the apparatus is arranged to be provided with data, associated with the element, upon association of the element with the apparatus, and wherein the computer program comprises computer code to control the circuitry for associating to provide the data to the apparatus.

According to fifth aspect, there is provided a computer program for a user portable element, the user portable element arranged to be associatable with a user portable electronic apparatus over a plurality of regions of the portable electronic apparatus, each region of the apparatus for allowing for association with the user portable element, wherein the user portable element comprises circuitry for associating and wherein the circuitry for associating is arranged to allow for the provision (e.g. transfer/unlocking) of data, associated with the element, to the apparatus upon association of the user portable element with the apparatus via one or more of the plurality of regions of the portable electronic apparatus, and wherein the computer program comprises computer code to control the circuitry for associating to provide the data to the apparatus.

According to a sixth aspect, there is provided a method of providing data to a portable electronic apparatus by associating the user portable electronic apparatus of any preceding user portable electronic apparatus claim with a user portable element according to any preceding user portable element claim.

According to a seventh aspect, there is provided a user portable electronic apparatus comprising means for associating with a user portable element, the means for associating providing a plurality of regions each allowing for association with the user portable element, and wherein the apparatus is arranged to be provided with data, associated with the element, upon association of the element with the apparatus.

According to an eighth aspect, there is provided a user portable element arranged to be associatable with a user portable electronic apparatus over a plurality of regions of the portable electronic apparatus, each region of the apparatus for allowing for association with the user portable element, wherein the user portable element comprises means for associating and wherein the means for associating is arranged to allow for the provision (e.g. transfer/unlocking) of data, associated with the element, to the apparatus upon association of the user portable element with the apparatus via one or more of the plurality of regions of the portable electronic apparatus.

According to a ninth aspect, there is provided a user portable electronic apparatus comprising circuitry for associating with a user portable element, the circuitry for associating providing a single region allowing for association with compatible circuitry for associating of the user portable element, and wherein the apparatus is arranged to be provided with data, associated with the element, upon association of the element with the apparatus, and wherein the respective circuitry for associating are located on respective major exterior faces of the apparatus and the element.

The present invention includes one or more aspects, embodiments or features in isolation or in various combinations whether or not specifically stated (including claimed) in that combination or in isolation. Associated methods of assembly are also within the present disclosure.

The above summary is intended to be merely exemplary and non-limiting.

### BRIEF DESCRIPTION OF THE DRAWINGS

A description is now given, by way of example only, with reference to the accompanying drawings, in which:—

FIG. 1 shows a schematic illustration of a user portable element according to one embodiment of the present invention;

FIG. 2 shows a schematic illustration of a user portable electronic apparatus according to one embodiment of the present invention;

FIG. 3 shows a schematic illustration of a user portable element and a user portable apparatus in-use in a number of embodiments of the present invention;

FIG. 4 illustrates various views (right hand side, front, left hand side, rear) of the exterior of a user portable apparatus (e.g. a mobile phone) according to one or more embodiments of the present invention;

FIG. 5 illustrates various graphic/text icon provided on respective major faces of user portable element according to one or more embodiments of the present invention, and the application of element on an apparatus according to one embodiment of the present invention; and

FIG. 6 illustrates the graphic/text icon for use with one or more embodiments of a user portable element according to the present invention.

### DETAILED DESCRIPTION OF SPECIFIC EMBODIMENTS

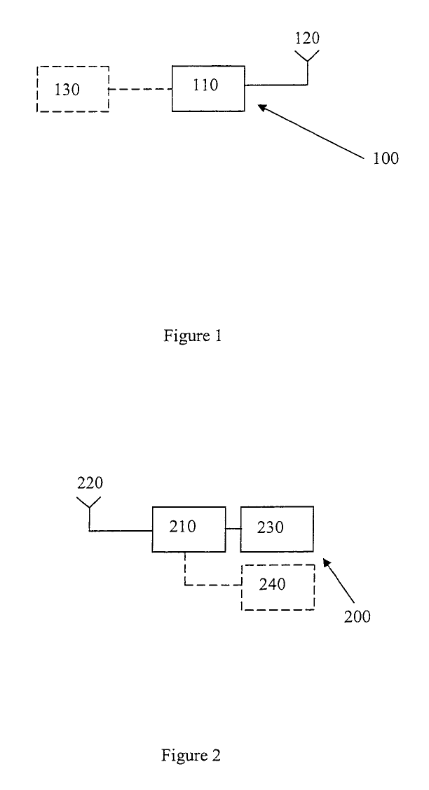

FIG. 1 provides a schematic illustration of the internal components of a user portable element 100 according to one embodiment of the present invention. By way of explanation, it may be first beneficial to explain one practical use of the user portable element 100.

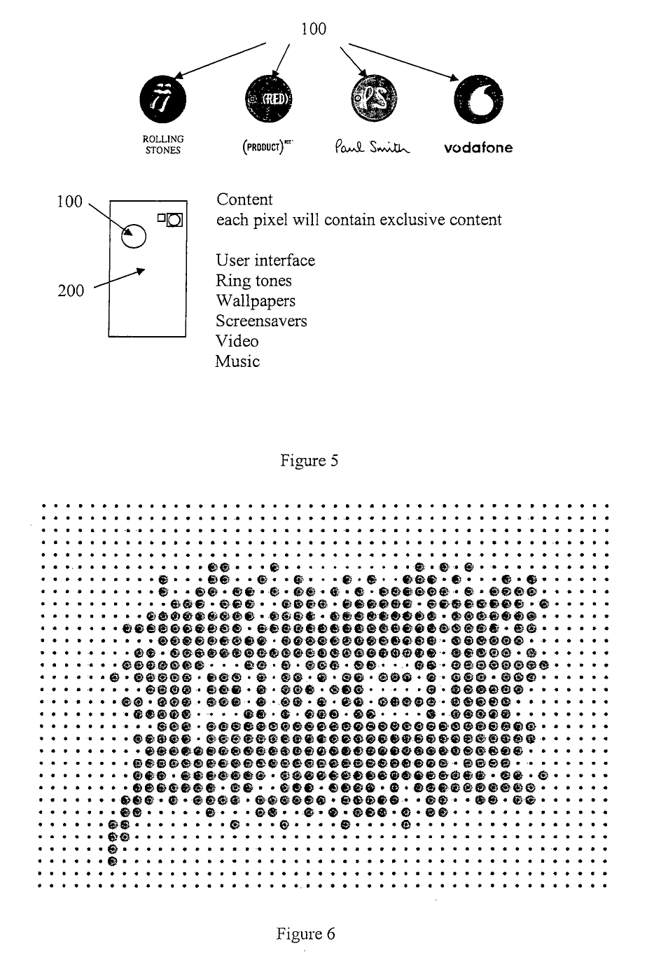

Consider that a user has a user portable apparatus 200, in this case a mobile telephone. He wants to purchase some additional data (e.g. an audio/video recording of a Rolling Stones™ concert, a polyphonic ringtone, a video game etc.) for use on his phone 200. The user purchases (at a real/virtual shop) a particular user portable element 100 (see FIG. 5) which can be used to provide the particular data for use on his phone 200. Once he has this element 100, in one embodiment, he merely places it near (without touching) to any of the major (e.g. front/rear) faces of the phone 200 to allow for the provision of the data to the phone 200. In another embodiment, he attaches it to/locates it on a major face (e.g. rear) of the phone.

In one embodiment, the user can place the element 100 anywhere on or over (without touching) a major face of the phone 200 (i.e. towards the top, middle, bottom, right, left, corner etc of a major face). In another embodiment, the user needs to locate the element 100 at/over (with/without touching) a particular location (e.g. a port or a defined region (including a recess/depression on a face)) on a major face (e.g. rear) of the phone 200 (shown to be towards the top left of the rear face in FIG. 5). In the case of FIGS. 4 and 5, the element 100 is for use with a mobile phone 200 comprising a display 280, alphanumeric keypad 281, on/off slider 282, volume keys 283, camera 270, and flash 271.

The provision of the data may be by direct transfer of the data contained on the element 100 (e.g. on flash memory) to the phone 200. The data provided to the phone may be locked/encrypted. In such a case, the unlocking/decryption key may be separately provided/obtained (e.g. downloadable from a website and/or provided with the sale of the element 100 to the user, the unlocking/decryption key being authorized for use at the point of sale (e.g. by the element vendor obtaining authorization from the data vendor following sale of the element)).

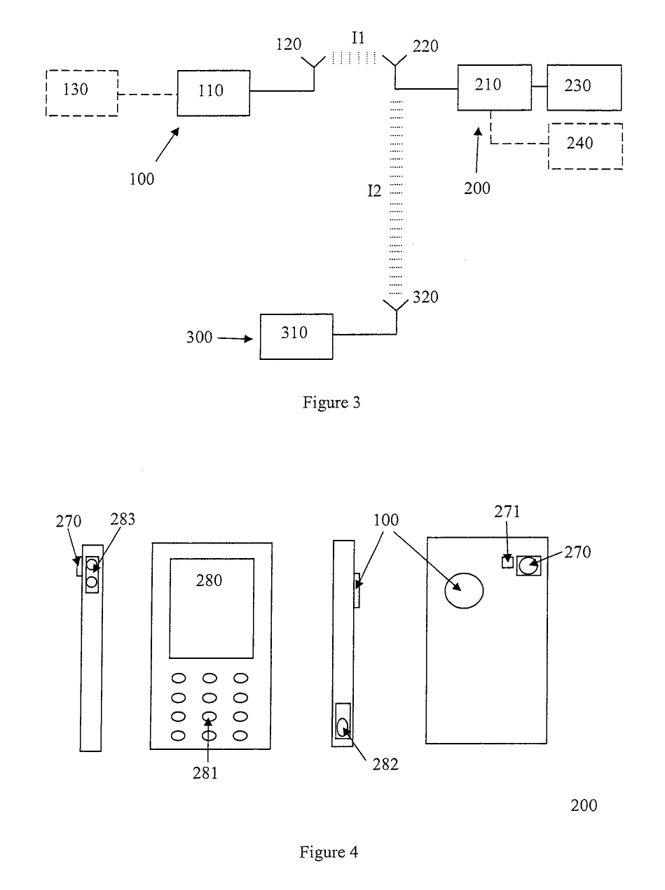

Rather than store the data on the element 100, the data may be indirectly provided by the element 100. This may be by providing a link (e.g. a weblink, and/or a number for SMS which will provide the data) which can be used to download the data from a remote source 300 (FIG. 3).

Another method for the provision of the data is by the element 100 providing a security code which can be used to unlock/decrypt the data. This locked/encrypted data may previously/subsequently obtained over the phone air-interface or a physical connection (e.g. from a memory card which is/has been connected to the phone 200).

The element 100 may comprise a temporary adhesive on a major face of the element 100 for use in temporarily attaching the element 100 to the phone 200. The user can then dispose of the element 100 once the data has been provided. More permanent adhesives may be used. With more permanent attaching arrangements, the element 100 may have light emitting elements (not shown) which may respond to incoming messages/calls or interact with other devices in the vicinity. Such light emitting elements may also be provided with less permanent attaching methods.

One or more locking arrangements (not shown) may be used to lock the element 100 to the phone 200. The locking arrangement may require 90 degree turning of the element 100 once it has been inserted into a complementary arrangement (not shown) in the phone 200. A tool may be used to lock/unlock the element 100 into/out of place (holes/apertures/recesses may be provided in/around/on the element 100 to enable engagement with the tool). In another embodiment, a tool may not be required, and the element may be locked into place by a user's hands.

The (e.g. locking) engagement of the element 100 to the phone 200 may automatically initiate the association of the element 100 and the phone to provide the data.

In one embodiment, the element 100 may be physically attached to the engine block of the phone 100. In other embodiments, the element 100 may not be physically attached to the phone, but may communicate with the phone 200 over an air interface (e.g. I1, FIG. 3).

Let us now consider the internal components of the element 100, as shown in FIG. 1. The element 100 comprises circuitry to allow it to be associated with the phone 200. In this case, the circuitry for associating comprises a circuitry for storing data 110 and circuitry for allowing the element 100 to be connected to the proximal phone 200 (i.e. circuitry for interfacing). In this case, the circuitry for interfacing comprises an RFID antenna 120. Certain embodiments of the element 100 may also comprise a power source 130 (e.g. battery). In the embodiment in which the circuitry for interfacing is provides RFID (i.e. it comprises an antenna RFID element 120), the element 100 could be considered to be acting like an RFID transponder.

The internal components of the phone 200 are shown in FIG. 2. The phone 200 may have additional circuitry (or the circuitry shown may have additional functionality) which would allow the phone 200 to operate as a mobile phone 200. Corresponding components to the element 100 have been numbered with corresponding numbers. The circuitry for associating comprises circuitry for interfacing 220 and circuitry for processing the data 210.

In particular, the circuitry for interfacing 220 comprises an RFID reader antenna. In certain embodiments, this same antenna 220 may be used for radiocommunication over the cellular network, although in other embodiments, respective dedicated antenna elements may be provided.

The antenna element 220 is connected to circuitry for processing the data 210. This circuitry is powered by a rechargeable power source 230 (battery). In certain embodiments, circuitry for a memory card/stick 240 may also be provided which is connected to the circuitry for processing 210.

In the embodiment in which the antenna element 220 is for use in RFID, the phone 200 could be considered to be an RFID reader. In such a case, multiple elements 100 can be associated with phone 200 when placed in close proximity (including in touching proximity) with the phone 200. These multiple elements 100 may be associated with the phone all at the same time or at different times. One element 100 may be associated with the phone over a number of regions (e.g. on the major face) of the phone 200. Multiple elements 100 may be each associated over one or more regions of the phone (e.g. on a major face of the phone).

In other embodiments, the antenna elements used in the circuitry for interfacing 120, 220 may be for Bluetooth™ transmission. In such a case, the Bluetooth™ (security) code of the element 100 may need to be separately provided to the phone 200 (or vice versa) to allow for the provision of the data. Such codes may be provided using respective user interfaces. The codes may be provided at the point of purchase of the element 100.

The respective antenna elements may be orientated such that they can be optimally used in planes parallel to a major face of the element 100, phone 200.

FIG. 3 shows the interfacing I1 between the element 100 and the phone 200, and also the optional interfacing I2 of the phone 200 with a remote data source 300. The interface I1 and I2 are shown to be air interfaces. However, certain embodiments may use one or more wired interfaces.

In certain embodiments, part, or all, of the data associated with the element 100 may be located on the remote data source 300, and the element 100 and phone 200 may be arranged such that the attachment of the element to the exterior face of the portable electronic device allows for the provision (e.g. transfer/unlocking) of the data from the remote source 300 to the phone 200.

In certain embodiments, part, or all, of the data associated with the element may be located on the remote data source 300, and the element/phone/remote source may be arranged such that the attachment of the element to the exterior face of the phone 200 allows for the provision (e.g. transfer/unlocking) of the data from the remote source 300 to the electronic device via an (e.g. indirect/direct) air interface which can be set up (e.g. automatically and/or using user-initiation) between the remote source 300 and the phone 200.

As an example, the element 100 may comprise 256 GB, 1 GB, or 2 GB of memory and have a diameter of upto the order of 13 mm, and thickness of up to the order of 5 mm. The element memory may comprise micro USD card, flash memory (USB memory stick), or the memory used with RFID transponders. The element memory may provide for read/write functions or provide a read only function.

In certain embodiments, rather than having antenna elements (i.e. circuitry for radiating), the circuitry for interfacing may comprise physical connection points.

It will be appreciated that the aforementioned circuitry may have other functions in addition to the mentioned functions, and that these functions may be performed by the same circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-31. (canceled)

32. A user portable electronic apparatus comprising:
circuitry for surface associating with a user portable data element, the circuitry for surface associating providing one or more surface regions each allowing for surface association with the user portable data element, and wherein the apparatus is configured to receive data associated with the data element, upon surface association of the data element with the apparatus via one or more of the provided surface regions of the user portable electronic apparatus.

33. An apparatus according to claim 32, wherein the surface region comprises an exterior major face of the apparatus.

34. An apparatus according to claim 32, wherein the circuitry for surface associating is configured to surface associate with the user portable data element using near field radio communication.

35. An apparatus according to claim 32, wherein the circuitry for surface associating comprises one or more antenna element(s) for RFID, the one or more antenna element(s) for RFID for surface associating the user portable data element with the apparatus.

36. An apparatus according to claim 32, wherein the apparatus is configured to be surface associated with the user portable data element upon physical surface contact of the apparatus and the user portable data element over one or more surface regions of the apparatus.

37. An apparatus according to claim 32, wherein the apparatus is configured to allow physical attachment of the user portable data element on an exterior surface of the apparatus to allow for the provision of the data from the data element to the apparatus upon physical attachment of the data element to the exterior surface of the apparatus.

38. An apparatus according to claim 37, wherein the apparatus is configured to provide physical attachment by engaging of the apparatus and the user portable data element with one another and then turning/twisting of them relative to one another.

39. An apparatus according to claim 32, wherein the apparatus is configured such that the surface association of the apparatus with the user portable data element allows for the transfer of data from a remote source to the apparatus, the remote source being remote from both the apparatus and the data element.

40. An apparatus according to claim 32, wherein the apparatus is configured such that the surface association of the apparatus with the user portable data element allows for the unlocking of data for the apparatus, the data being located on user portable element, the apparatus or a remote source to the data element/apparatus.

41. An apparatus according to claim 40, wherein the apparatus is configured such that the surface association of the apparatus with the user portable data element allows for the unlocking of data for the apparatus located on a user removable circuit which is to be/has been read by the apparatus.

42. An apparatus according to claim 39, wherein apparatus comprises circuitry for far-field communications, and wherein the apparatus is configured such that the association of the apparatus and the user portable data element allows for the provision of data to the apparatus from a remote source using the circuitry for far-field communications.

43. An apparatus according to claim 32, wherein the circuitry for associating is configured to be able to associate with multiple user portable data elements at one time.

44. A user portable data element configured to be associatable with a user portable electronic apparatus over one or more regions of the portable electronic apparatus, each region of the apparatus allowing for surface association of the user portable data element with the user portable electronic apparatus, wherein the user portable data element comprises circuitry for surface associating configured to allow for data, associated with the data element, to be provided to the apparatus upon surface association of the user portable data element with the apparatus via one or more of the provided surface regions of the portable electronic apparatus.

45. A user portable data element according to claim 44, wherein the data element is configured to provide one or more security codes using the circuitry for surface associating to allow the apparatus to be provided with the data.

46. A computer program for a user portable electronic apparatus, the apparatus comprising circuitry for surface associating with a user portable data element, the circuitry for surface associating providing one or more surface regions each allowing for surface association with the user portable data element, and wherein the apparatus is configured to receive data, associated with the data element, upon surface association of the data element with the apparatus via one or more of the provided surface regions of the user portable electronic apparatus, and wherein the computer program comprises computer code to control the circuitry for surface associating to provide the data to the apparatus.

47. A computer program for a user portable data element, the user portable element configured to be associatable with a user portable electronic apparatus over one or more regions of the portable electronic apparatus, each region of the apparatus allowing for surface association of the user portable data element with the user portable electronic apparatus, wherein the user portable data element comprises circuitry for surface associating configured to allow for data, associated with the data element, to be provided to the apparatus upon surface association of the user portable data element with the apparatus via one or more of the provided surface regions of the portable electronic apparatus, and wherein the computer program comprises computer code to control the circuitry for surface associating to provide the data to the apparatus.

48. A method of providing data to a portable electronic apparatus by associating the user portable electronic apparatus of with a user portable data element.

49. A user portable electronic apparatus according to claim 32, wherein the data is content data, the content data comprising one or more of audio/video content data from the list comprising concert recording data, music data, ringtone data, polyphonic ringtone data, wallpaper data, screen saver data, video game data, user interface data, the content data for use by a user using the apparatus.

50. A user portable electronic apparatus according to claim 32, wherein the circuitry for surface associating is defined by a recess/depression in a major face of the apparatus.

51. A user portable electronic apparatus according to claim 32, wherein the apparatus is configured to automatically receive the data, associated with data element, upon surface association of the data element with the apparatus via one or more of the provided surface regions of the user portable electronic apparatus.
